(19) United States
(12) Patent Application Publication
(10) Pub. No.: US 2008/0109863 A1
(43) Pub. Date: May 8, 2008

(54) Video apparatus and signal processing method thereof

(75) Inventor: Han-Hsing Ying, Tao Yuan Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/806,916

(22) Filed: Jun. 5, 2007

(30) Foreign Application Priority Data
Nov. 8, 2006 (TW) 95141403

(51) Int. Cl. H04N 7/173

(52) U.S. Cl. 725/110

(57) ABSTRACT

A video apparatus including a processing unit, a tuner, a video processor, a network unit and an information-converting module is provided. The tuner receives a video signal. The information-converting module includes a download module, an analysis module and a graphics module. The download module downloads a web page with internet content from the web page server through the network unit. The analysis module analyzes the web page to obtain the internet content. The graphic module converts the internet content into a graphic data. The video processor can combine the graphic data with the video signal and output a combination signal. A signal processing method of the video apparatus is provided also.

### RELATED APPLICATIONS

This application claims priority to Taiwan Application Serial Number 95141403, filed Nov. 8, 2006, which is herein incorporated by reference.

### BACKGROUND

1. Field of Invention

The present invention relates to a video apparatus and signal processing method thereof, and more particularly, to a video apparatus with an internet content display function and signal processing method thereof.

2. Description of Related Art

In recent years, the Internet has become a major information source for people. The internet provides constant or changeable daily information, e.g. weather information, financial information and traffic condition information. In general, people use computers to connect to the internet and retrieve the internet content. However, for some people, computers are not easy to use. On the other hand, video apparatuses such as televisions and set-top-boxes are user-friendly. However, those devices can only display either the internet content or the TV broadcasting. In other words, users have to choose between surfing the internet or watching television when they use the video apparatuses. Moreover, another problem is that users cannot know whether or not the internet content is real-time updated when they retrieve information from the internet using conventional video apparatuses.

Accordingly, it is desirable to provide a video apparatus and a signal processing method thereof, which can simultaneously display TV programs and internet content. It is also desirable to provide a video apparatus and a signal processing method thereof, which allow users to obtain real-time updated information.

### SUMMARY

It is an aspect of the present invention to provide a video apparatus with an internet content display function, which can display video and internet content simultaneously, so that users can obtain internet content when they watch TV programs.

It is another aspect of the present invention to provide a video apparatus with an internet content display function, which can refresh the internet content automatically, so that the internet content can be real-time updated.

It is yet another aspect of the present invention to provide a video apparatus with an internet content display function, which can determine the update time of the internet content so as to prevent users from obtaining out-of-date information.

In accordance with an embodiment of the present invention disclosed herein, a video apparatus including a processing unit, a tuner, a video processor, a network unit and an information-converting module is provided. The tuner is configured to receive a video signal. The video processor is coupled with the processing unit and the tuner. The network unit is coupled with the processing unit and a web page server. The information-converting module is coupled with the processing unit and includes a download module, an analysis module and a graphic module. The download module is configured to download a web page with internet content from the web page server through the network unit. The analysis module is configured to analyze the web page to obtain the internet content. The graphic module is configured to convert the internet content into a graphic data. The video processor can combine the graphic data with the video signal and output a combination signal.

In accordance with an embodiment of the present invention, the video apparatus can simultaneously display TV programs and internet content, so that users can obtain internet content when they watch TV programs.

In accordance with an embodiment of the present invention, the video apparatus includes an information-updating module to transmit an update request to the download module automatically at regular intervals, so that the internet content can be real-time updated.

In accordance with an embodiment of the present invention, the video apparatus includes a menu module to store item data, which allows users to select and obtain the internet contents.

In accordance with an embodiment of the present invention, the video apparatus includes a calculator module to calculate the internet content.

In accordance with an embodiment of the present invention, a signal processing method of a video apparatus is provided. The method begins by downloading a web page with internet content from a web page server. Then, the web page is analyzed to obtain the internet content. The internet content is converted into a graphic data. Subsequently, the graphic data and a video signal are combined to generate a combination signal.

It is to be understood that both the foregoing general description and the following detailed description are by examples and are intended to provide further explanations of the invention as claimed.

### BRIEF DESCRIPTION OF THE DRAWINGS

These and other features, aspects and advantages of the invention will become apparent by reference to the following description and accompanying drawings, which are given by way of illustration only, and thus are not limitative of the invention, wherein:

FIG. 1 is a block diagram of a video apparatus according to one preferred embodiment of the present invention;

FIG. 2 is a flowchart showing a signal processing method according to one preferred embodiment of this invention;

FIG. 3 illustrates a display screen according to a preferred embodiment of the present invention;

FIG. 4 is a block diagram representing an exemplary information-converting module in accordance with the present invention; and

FIG. 5 illustrates a system menu according to a preferred embodiment of the present invention.

### DESCRIPTION OF THE PREFERRED EMBODIMENTS

In general, conventional video apparatuses, such as televisions and set-top-boxes, can display either TV programs or internet content. Users cannot obtain internet content and watch television simultaneously. In accordance with an embodiment of the present invention, a video apparatus with an internet content display function is provided. The video apparatus can simultaneously display TV programs and internet content. Moreover, the video apparatus can ensure that users obtain real-time updated information.

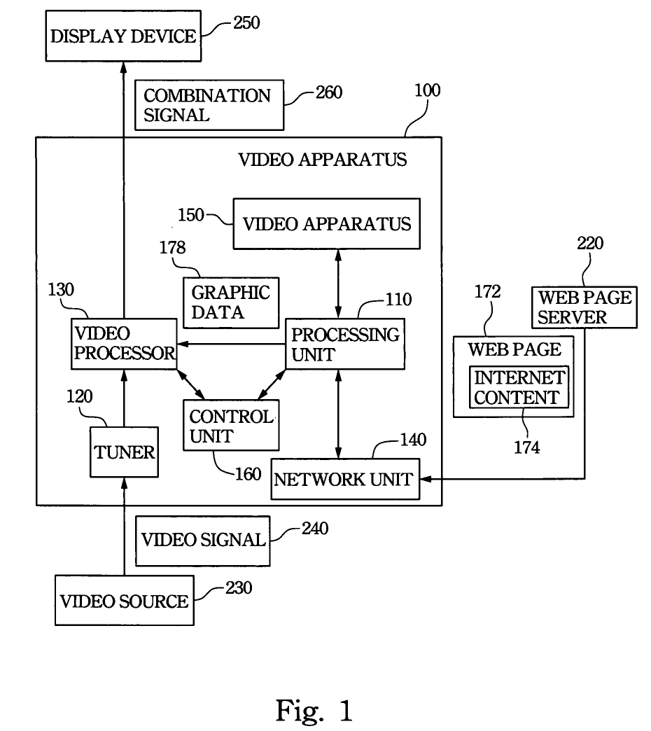

FIG. 1 is a block diagram of a video apparatus according to one preferred embodiment of the present invention. Referring to FIG. 1, a video apparatus 100 includes a processing unit 110, a tuner 120, a video processor 130, a network unit 140 and an information-converting module 150. The video processor 130, the network unit 140 and the information-converting module 150 are coupled with the processing unit 110. The tuner 120 is coupled with the video processor 130. The video apparatus 100 may be a set-top-box, which can display video on a display device. The video apparatus 100 may be a television with an internet content display function also.

More specifically, the tuner 120 can receive video signal 240 transmitted from the video source 230 through the wire/wireless technology. Depending on the video signal 240, the tuner 120 may be a digital tuner or an analog tuner. The network unit 140, such as an Ethernet controller chip, includes a Physical Layer (PHY) and a Media Access Control (MAC) element. The network unit 140 is coupled with the web page server 220 and is capable of downloading a web page 172 therefrom. The web page 172 includes internet content 174, e.g. information about the weather and stock market.

The processing unit 110 may be a microprocessor. The information-converting module 150 may be a circuit or software executed on the processing unit 110. For example, an embedded system including the processing unit 110 and the information-converting module 150 can transform the internet content 174 into a graphic data 178. The video processor 130 combines the graphic data 178 with the video signal 240 and outputs the combination signal 260 to the display device 250.

With continued reference to FIG. 1, the video apparatus 100 can further include a control unit 160, such as a control panel or a remote controller, to input control signals or data. The control unit 160 coupled with the processing unit 110 and the video processor 130 can transmit the control signal to the processing unit 110 and the video processor 130. After that, the processing unit 110 transmits the graphic data 178 to the video processor 130 which combines the graphic data 178 with the video signal 240 and outputs the combination signal 260 to the display device 250. Accordingly, users can control whether or not the display device 250 shows the graphic data 178 by using the control unit 160. The video processor 130 can also control the position of the graphic data 178, for example, at the top-right corner or the bottom-left corner of the display device 250, thus reducing appearance interference caused by the graphic data 178. Moreover, the video processor 130 can resize the graphic data 178 to fit with the display device 250.

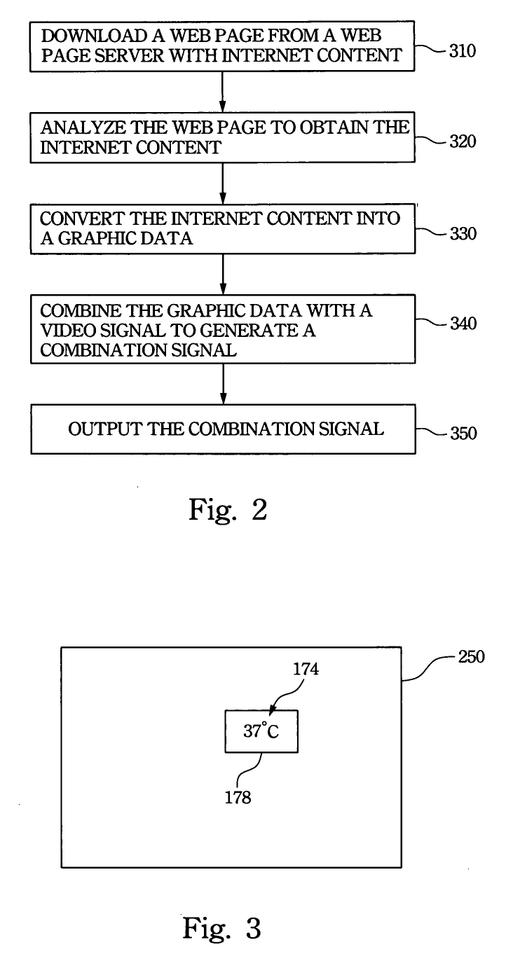

In FIG. 1, for example, the information-converting module 150 can store the name and the address of the web page server 220 in advance to enhance the operating convenience for users. The web page server 220 stores the web page 172 with internet content, such as the real-time temperature information. FIG. 2 is a flowchart showing a signal processing method according to one preferred embodiment of this invention. With reference to FIG. 1 and FIG. 2, in step 310, a web page is downloaded from the predetermined web page server 220 by the information-converting module 150. Subsequently, in step 320, the information-converting module 150 retrieves the temperature information by analyzing the web page. For example, the web page may be written in Hyper Text Markup Language (HTML) or Extensible Markup Language (XML). The information-converting module 150 can retrieve the temperature information by analyzing the tag and the contents of the web page.

In step 330, the information-converting module 150 converts the temperature information into graphic data 178, e.g., a bitmap format file and transmits the graphic data 178 to the video processor 130. Then, in step 340, the video processor 130 combines the graphic data 178 with the video signal 240 to generate the combination signal 260. In step 350, the video processor 130 outputs the combination signal 260 to the display device 250. Thus, users can obtain the temperature information when the video apparatus 100 display the combination signal 260. Moreover, the size and the position of the graphic data 178 can be adjusted by using the video processor 130.

FIG. 3 illustrates a display screen according to a preferred embodiment of the present invention. When the display device 250 displays the combination signal 260, the video signal 240 (TV programs) and the graphic data 178 are shown simultaneously. Thus, users can obtain the internet content 174 when they watch TV programs.

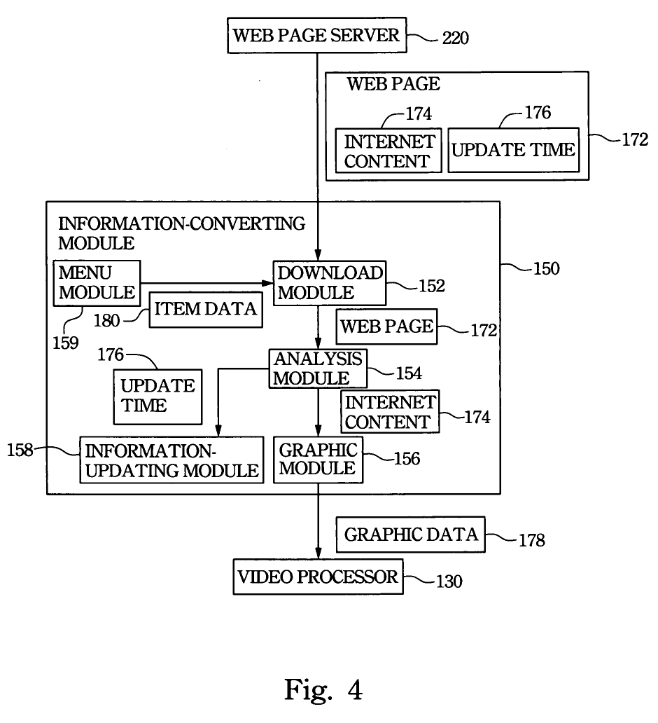

FIG. 4 is a block diagram representing an exemplary information-converting module in accordance with the present invention. The information-converting module 150 includes a download module 152, an analysis module 154 and a graphic module 156. The download module 152 downloads the web page 172 with the internet content 174 from the web page server 220. The analysis module 154 analyses the web page 172 to obtain the internet content 174. The graphic module 156 converts the internet content 174 into the graphic data 178.

In accordance with an embodiment of the present invention, the information-converting module 150 includes an information-updating module 158 and a menu module 159. When the internet content 174 is changeable, the information-updating module 158 transmits an update request to the download module 152 automatically at regular intervals, e.g. every one minute. Thus, the download module 152 can refresh the internet content 174 by downloading the web page 172 at regular intervals so as to ensure the internet content 174 is real-time updated. Moreover, the content of the web page 172 may include an update time 176 to indicate when the content of the web page 172 is updated. The information-updating module 158 can determine whether a period of time from the update time 176 to system time of the video apparatus exceeds a predetermined interval. The information-updating module 158 can display a warning message on the display device 250 if it is determined that the period of time exceeds the predetermined interval. Thus, users can know whether the internet content 174 is updated promptly even when the connection is broken or the web page server 220 malfunctions.

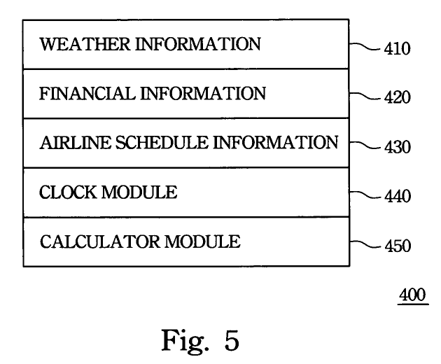

FIG. 5 illustrates a system menu according to a preferred embodiment of the present invention. Referring to FIG. 4 and FIG. 5, the menu module 159 is capable of displaying the system menu 400 on the display device. The system menu 400 may include weather information 410, financial information 420 and airline schedule information 430. When users select an item of the system menu 400, the menu module 159 transmits the corresponding item data 180 to the download module 152. The item data 180 may include the address of the web page server 220, so that the download module 152 can download the web page 172 from the web page server 220 according to the item data 180. The menu module 159 may include a clock module 440 to display the system time built in the video apparatus without having to download information from the internet. Moreover, the menu module 159 may include a calculator module 450 to calculate the internet content 174 also.

In accordance with an embodiment of the present invention, the video apparatus can display video and internet content simultaneously, so that users can obtain internet content when they watch TV programs.

In accordance with an embodiment of the present invention, the video apparatus can refresh the internet content by downloading the web pages at regular intervals automatically, so that the internet content can be real-time updated.

In accordance with an embodiment of the present invention, the video apparatus can display warning message on the display, so as to avoid users obtaining out-of-date information.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A video apparatus with an internet content display function, comprising:
a processing unit;
a tuner for receiving a video signal;
a video processor, coupled with the processing unit and the tuner;
a network unit, coupled with the processing unit and a web page server; and
an information-converting module, coupled with the processing unit, including:
a download module, configured to download a web page from the web page server through the network unit, wherein the web page contains internet content;
an analysis module, configured to analyze the web page to obtain the internet content; and
a graphic module, configured to convert the internet content into a graphic data,
wherein the video processor is configured to combine the graphic data with the video signal and output a combination signal.

2. A video apparatus with an internet content display function as recited in claim 1, further comprising a control unit coupled with the processing unit and the video processor, wherein the control unit is configured to input a control signal to control the display of the graphic data.

3. A video apparatus with an internet content display function as recited in claim 1, wherein the information-converting module has an information-updating module to transmit an update request to the download module at regular intervals.

4. A video apparatus with an internet content display function as recited in claim 1, wherein the information-converting module has a menu module to store an item data.

5. A video apparatus with an internet content display function as recited in claim 4, wherein the item data includes the address of the web page server.

6. A video apparatus with an internet content display function as recited in claim 4, wherein the menu module has a calculator module to calculate the internet content.

7. A video apparatus with an internet content display function as recited in claim 1, further comprising a display device to display the combination signal.

8. A video apparatus with an internet content display function as recited in claim 1, wherein the graphic data is a bitmap format file.

9. A video apparatus with an internet content display function, comprising:
a processing unit;
a tuner for receiving a video signal;
a video processor, coupled with the processing unit and the tuner;
a network unit, coupled with the processing unit and a web page server;
a control unit, coupled with the processing unit and the video processor; and
an information-converting module, coupled with the processing unit, including:
a download module, configured to download a web page from the web page server through the network unit, wherein the web page contains internet content;
an analysis module, configured to analyze the web page to obtain the internet content; and
a graphic module, configured to convert the internet content into a graphic data;
an information-updating module, configured to transmit an update request to the download module at regular intervals; and
a menu module, configured to store item data including the address of the web page server,
wherein the video processor is configured to combine the graphic data with the video signal and output a combination signal and wherein the control unit is configured to input a control signal to control the display of the graphic data

10. A signal processing method of a video apparatus, comprising:
downloading a web page with internet content from a web page server;
analyzing the web page to obtain the internet content;
converting the internet content into a graphic data; and
combining the graphic data with a video signal.

11. A signal processing method of a video apparatus as recited in claim 10, further comprising the step of updating the internet content by downloading the web page from the web page server at regular intervals.

12. A signal processing method of a video apparatus as recited in claim 10, further comprising the step of determining whether a period of time from an update time to the system time of the video apparatus exceeds a predetermined interval.

13. A signal processing method of a video apparatus as recited in claim 10, further comprising the step of inputting an item data with the address of the web page server.

14. A signal processing method of a video apparatus as recited in claim 10, further comprising the step of outputting a combination signal to a display device.
